(19) United States
(12) Patent Application Publication
(10) Pub. No.: US 2008/0186427 A1
(43) Pub. Date: Aug. 7, 2008

(54) BACKLIGHT ASSEMBLY

(75) Inventors: Woo-Jun KIM, Yongin-si (KR); Jun-Young LEE, Yongin-si (KR); Sung-Wook KANG, Seoul (KR); Jae-Joong KWON, Suwon-si (KR); Sung-Kyu SHIM, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/023,717

(22) Filed: Jan. 31, 2008

(30) Foreign Application Priority Data
Feb. 2, 2007 (KR) 10-2007-0010970

(51) Int. Cl. G02F 1/1335; F21V 7/04

(52) U.S. Cl. 349/62; 362/247

(57) ABSTRACT

The present invention provides a backlight assembly including a light guide having a plurality of grooves disposed in at least one side, a light source arranged at least one end of the light guide, and a reflecting plate arranged below the light guide to reflect light emitted from the light guide.

### CROSS REFERENCE TO RELATED APPLICATION

This application claims priority from and the benefit of Korean Patent Application No. 10-2007-0010970, filed Feb. 2, 2007, which is hereby incorporated by reference for all purposes as if fully set forth herein.

### BACKGROUND OF THE INVENTION

1. Field of the Invention

The present invention relates to a backlight assembly, and more particularly, to a backlight assembly having a light guide with a plurality of grooves.

2. Discussion of the Background

A liquid crystal display (LCD) is a non-emissive flat panel display device that does not generate light by itself and therefore needs external light or ambient light to display an image. A backlight assembly may be mounted in the bottom of an LCD to emit light.

LCDs are widely used in various industrial fields because they are lightweight, thin, and have low power consumption. A typical LCD includes an LCD panel in which liquid crystal cells are arranged in a matrix between two substrates, a driving circuit portion to drive the LCD panel, and a backlight assembly to supply light to the LCD panel.

A backlight assembly may be a direct light type or an edge light type depending on how the light source is arranged. With a direct light type, light is irradiated to an LCD panel from a plurality of light sources installed directly below the LCD panel, whereas with an edge light type, light is irradiated to the LCD panel from a light source installed on a sidewall of a light guide panel.

A cold cathode fluorescence lamp (CCFL) may be used as a light source of a backlight assembly for large-scale LCDs. A CCFL is a long, slim light source that may serve as a surface-light source module through an appropriate conversion process. A light emitting diode (LED) may be used as a light source of a backlight assembly for a portable display device such as a cellular phone. LEDs are also increasingly being used for large-scale LCDs.

When an LED is used as a light source of a backlight assembly, an LED array is used. In this instance, since a point light source array is used instead of a CCFL, which is a line light source, a hot spot may occur around each LED.

A hot spot causes the area around an LED to appear relatively brighter than other portions of the display. Therefore, a hot spot causes a deviation in brightness between an area around an LED and other portions of the display.

### SUMMARY OF THE INVENTION

The present invention provides a backlight assembly in which a backlight assembly having an LED and a plurality of light guides is employed to prevent brightness deviation between a portion around an LED and the other portions of the display.

Additional features of the invention will be set forth in the description which follow, and in part will be apparent from the description, or may be learned by practice of the invention.

The present invention discloses a backlight assembly including a light guide having a long stick shape with a rectangular cross-section and including a plurality of emitting patterns in both side of the light guide, a light source arranged at least one end of the light guide, and a reflecting plate arranged below the light guide to reflect light emitted from the light guide.

The present invention also discloses a backlight assembly including a light guide, a first driving circuit board arranged at least one end of the light guide and including a first light source, and a bottom chassis accommodating the light guide and the first driving circuit board, wherein the first driving circuit board is arranged on a first side of the bottom chassis.

The present invention also discloses a liquid crystal display apparatus including a display panel and a backlight assembly. The display panel includes a first substrate, a second substrate facing the first substrate and a liquid crystal layer between the first substrate and the second substrate. The backlight assembly includes a light guide having a long stick shape with a rectangular cross-section and having a plurality of emitting patterns in both side of the light guide and a light source arranged at least one end of the light guide.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing an LCD having a backlight assembly according to an exemplary embodiment of the present invention.

FIG. 2 is a perspective view showing the backlight assembly according to an exemplary embodiment of the present invention.

FIG. 3 is a plan view showing a light guide according to an exemplary embodiment of the present invention.

FIG. 4 is a perspective view showing the light guide of FIG. 3.

FIG. 5 is a plan view showing a light guide according to another exemplary embodiment of the present invention.

FIG. 6 is a perspective view showing the light guide of FIG. 5.

FIG. 7 is a plan view showing a light guide according to another exemplary embodiment of the present invention.

FIG. 8 is a perspective view showing the light guide of FIG. 7.

FIG. 9 is a plan view showing a light guide according to another exemplary embodiment of the present invention.

FIG. 10 is a perspective view showing the light guide of FIG. 9.

FIG. 11 is a plan view showing a light guide according to another exemplary embodiment of the present invention.

FIG. 12 is a perspective view showing the light guide of FIG. 11.

FIG. 13 is a cross-sectional view showing a backlight assembly according to a first exemplary embodiment of the present invention.

FIG. 14 is a cross-sectional view showing a backlight assembly according to a second exemplary embodiment of the present invention.

FIG. 15 is a cross-sectional view showing a backlight assembly according to a third exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

It will be understood that when an element such as a layer, film, region or substrate is referred to as being “on”, “connected to”, or “coupled to” another element or layer, it can be directly on, directly connected to, or directly coupled to the other element or layer, or intervening elements or layers may also be present. In contrast, when an element is referred to as being “directly on”, “directly connected to”, or “directly coupled to” another element or layer, there are no intervening elements or layers present.

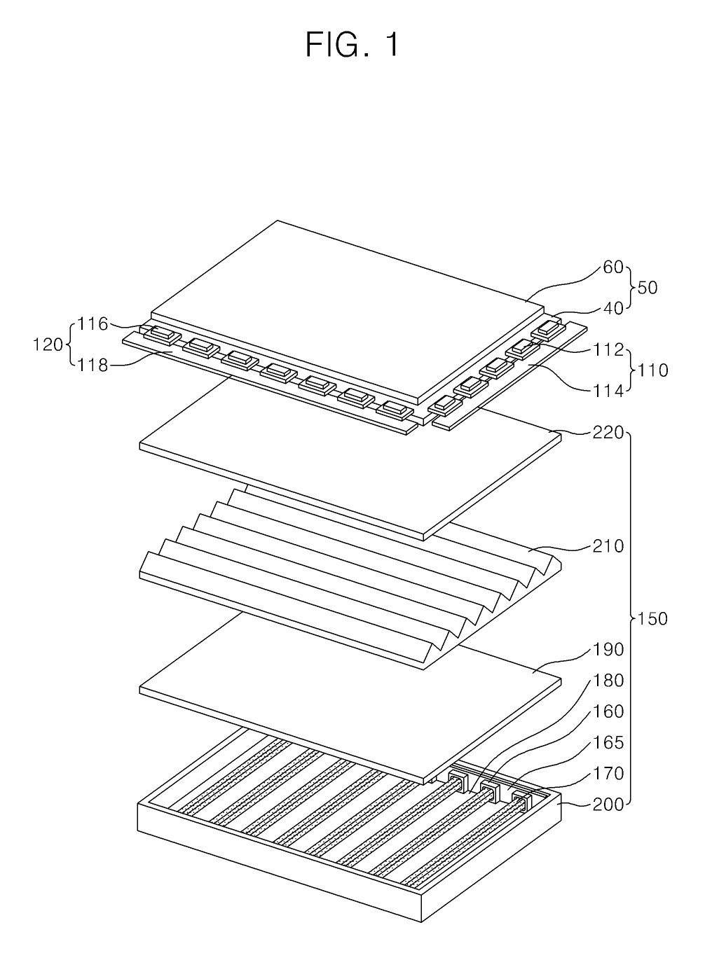

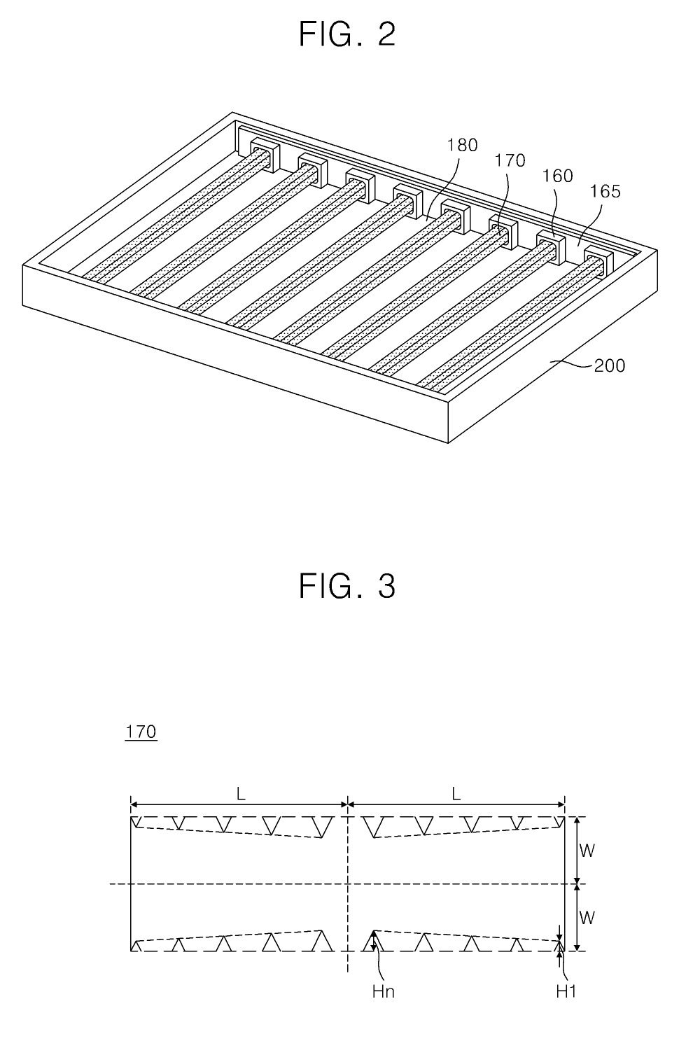

FIG. 1 is an exploded perspective view showing an LCD having a backlight assembly according to an exemplary embodiment of the present invention, and FIG. 2 is a perspective view showing the backlight assembly according to the exemplary embodiment of the present invention.

Referring to FIG. 1 and FIG. 2, an LCD according to an exemplary embodiment of the present invention comprises an LCD panel 50, panel driving portions 110 and 120, a backlight assembly 150, and a bottom chassis 200.

The LCD panel 50 comprises a thin film transistor (TFT) array substrate 40, a color filter array substrate 60, and a liquid crystal layer (not shown) to adjust light transmissivity interposed therebetween.

The color filter array substrate 60 includes a black matrix to prevent light leakage, a color filter to realize various colors, a common electrode to form a vertical electric field together with a pixel electrode, and an upper alignment layer to align liquid crystal molecules in the liquid crystal layer.

The TFT array substrate 40 includes gate lines arranged in a transverse direction, data lines arranged in a longitudinal direction and crossing the gate lines, TFTs disposed at the crossings of the gate and data lines, pixel electrodes connected to the TFTs, and a lower alignment layer to align the liquid crystal molecules.

The panel driving portions 110 and 120 include a gate driving portion 110 to drive the gate lines and a data driving portion 120 to drive the data lines.

The gate driving portion 110 includes a gate printed circuit board (PCB) 114 and a gate integrated circuit (IC) 112 mounted on a gate tape carrier package (TCP) disposed between the gate PCB 114 and the TFT array substrate 40.

The gate IC 112 sequentially supplies a scan signal of a gate high voltage to the gate lines during a portion of a time period and supplies a scan signal of a gate low voltage to the gate lines for the remainder of the time period. The gate PCB 114 supplies a control signal and a power signal to the gate IC 112 from a timing controller and a power source mounted on a data PCB 118.

The data driving portion 120 includes the data PCB 118 and a data IC 116. The data IC 116 is mounted on a data TCP disposed between the data PCB 118 and the TFT array substrate 40.

The data IC 116 converts pixel data into an analog pixel signal and supplies it to the data lines. The data PCB 118 supplies a control signal, a power signal, and pixel data to the data IC 116 from the timing controller and the power source.

The backlight assembly 150 is arranged below the LCD panel 50 to supply light to the LCD panel 50.

The bottom chassis 200 is arranged below the backlight assembly 150 to accommodate and protect the backlight assembly 150.

The backlight assembly 150 includes a light source 160, a light source driving circuit board 165, a light guide 170, a reflecting plate 180, and a diffusing plate 190.

A plurality of LEDs may be used as the light source 160. The light source driving circuit board 165 supplies a signal to the LEDs in response to an external driving signal to let the LEDs emit light. The light source driving circuit board 165 may be a flexible printed circuit (FPC) or PCB. The light source driving circuit board 165 is connected to the power source and has electrodes disposed at both ends thereof. The electrodes supply driving power to the LEDs in response to the external driving signal. The light source driving circuit board 165 and the light source 160 may be arranged on one side or both sides of the bottom chassis 200. Thus, although hidden from view in FIG. 1, the light source driving circuit board 165 and the light source 160 may also be arranged on the left side of the bottom chassis 200.

A plurality of light guides 170, which each may have a long stick shape, are provided, and the light guides 170 are arranged parallel to each other. Each light guide 170 may serve to efficiently guide light from the LEDs toward the LCD panel 50. Each light guide 170 may be made of a transparent polymer material, such as polymethylmetacrylate (PMMA) or poly carbonate (PC).

Each light guide 170 may have a plurality of grooves disposed on its top and bottom. The depth of the grooves increases approaching the center of the light guide 170 from both ends. The grooves may be either spaced apart from each other or arranged without any gap therebetween. The grooves may serve to improve the efficiency of light emitted from the light guide 170, particularly from sides of the light guide 170.

The light guide 170 is arranged to cross a longitudinal direction of a prism of a prism sheet 210 to be described later. The light guide 170 may have a length corresponding to that of a short side of the bottom chassis 200, and therefore, the light guide 170 can be made relatively short, which may make it possible to prevent the light guide from being bent during a manufacturing process.

The reflecting plate 180 is arranged below the light guide 170 and serves to efficiently reflect and refract incident light upward. The reflecting plate 180 may contain diffusion beads to efficiently reflect and refract light upward.

The diffusing plate 190 is arranged above the light guide 170 and serves to uniformly diffuse light reflected by the reflecting plate 180.

A diffusing sheet (not shown) may be further arranged above the light guide 170. The diffusing sheet directs incident light vertically from the light guide 170 and the reflecting plate 180 to the LCD panel and uniformly diffuses light to have a wide and uniform distribution before being irradiated to the LCD panel. A transparent resin film, in which a predetermined light diffusing member is coated on both sides thereof, may be used as the diffusing sheet.

This exemplary embodiment may be implemented as a dual-diffusing plate structure by providing another diffusing plate above the light guide 170 instead of the diffusing sheet.

A prism sheet 210 is arranged above the diffusing plate 190 and refracts and condenses light from the diffusing plate 190, which may improve brightness. The prism sheet 210 converts inclined incident light to vertical incident light in order to increase the efficiency incident on the LCD panel 50. Two sheets of horizontal and vertical prism sheets 210 may be arranged according to a product characteristic.

A protector sheet 220 is arranged above the prism sheet 210 and protects the optical sheets, which are sensitive to dust or scratches.

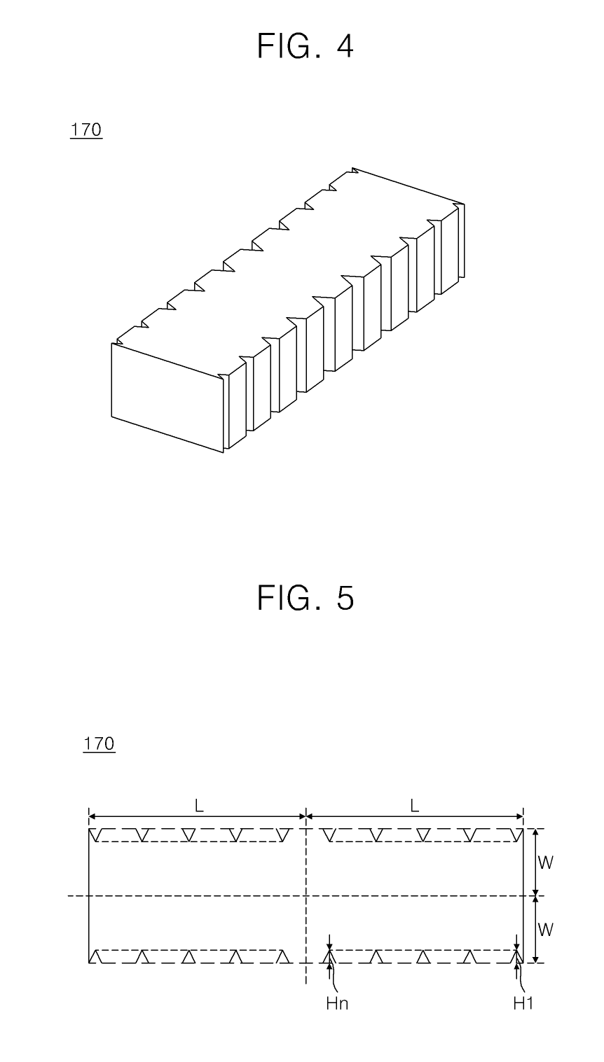

FIG. 3 is a plan view showing the light guide according to an exemplary embodiment of the present invention, and FIG. 4 is a perspective view showing the light guide of FIG. 3.

Referring to FIG. 3 and FIG. 4, the light guide 170 has a plurality of grooves, which are spaced apart from each other. The distance from each end of the light guide 170 to the center of the light guide is designated L. The depth of the grooves increases approaching the center of the light guide 170 from both ends. The grooves may be symmetrical with respect to the horizontal and vertical central axes of the light guide 170.

When light is emitted from the light source to the light guide 170, the light guide 170 guides light toward the LCD panel.

Light can be efficiently guided by the light guide 170 because the depth Hn of each groove at the center is greater than that H1 at an end of the light guide 170 and light can be efficiently condensed and refracted by forming the grooves in the shape of the letter “V” because “V”-shaped grooves may perform the same function as that of the prism sheet 210 of FIG. 1.

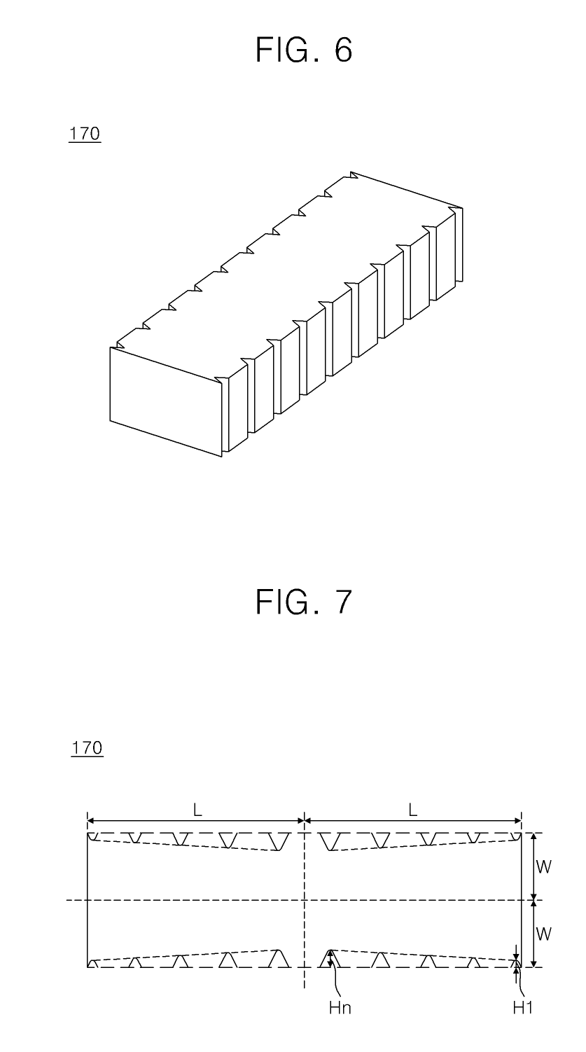

FIG. 5 is a plan view showing a light guide according to another exemplary embodiment of the present invention, and FIG. 6 is a perspective view showing the light guide of FIG. 5. The light guide of FIG. 5 and FIG. 6 has a similar configuration to the light guide of FIG. 3 and FIG. 4 except that the grooves have the same depth.

Referring to FIG. 5 and FIG. 6, the grooves of the light guide 170 have the same depth at both ends and the center of the light guide 170. In other words, Hn is equal to H1.

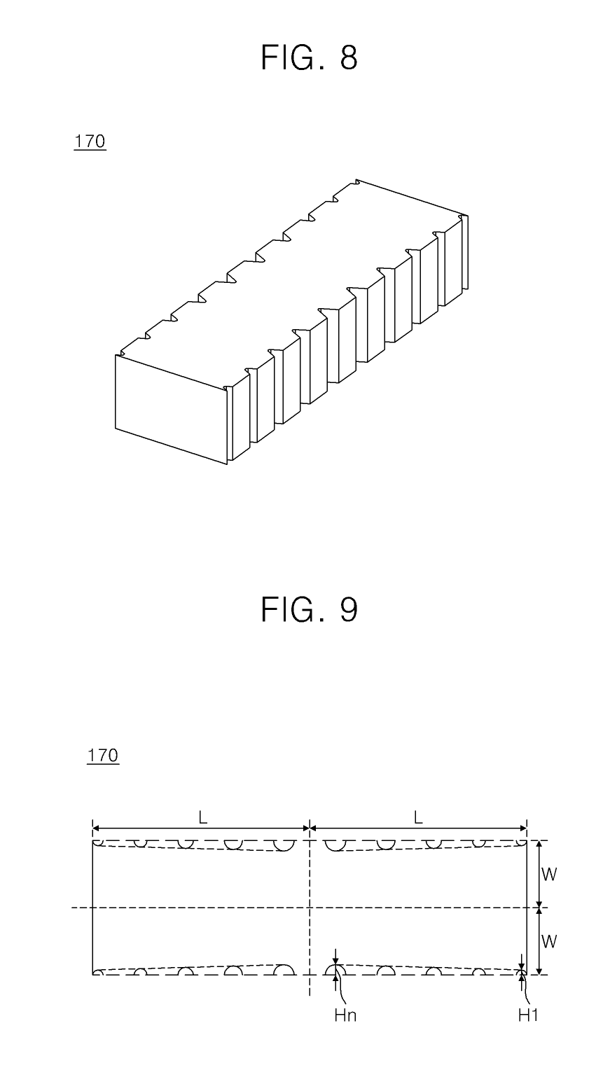

FIG. 7 is a plan view showing a light guide according to another exemplary embodiment of the present invention, and FIG. 8 is a perspective view showing the light guide of FIG. 7. The light guide of FIG. 7 and FIG. 8 has a similar configuration to the light guide of FIG. 3 and FIG. 4 except that the vertex of each groove is rounded.

Although each groove is shown to be rounded at the vertex in FIGS. 7 and 8, other portions of each groove may also be rounded.

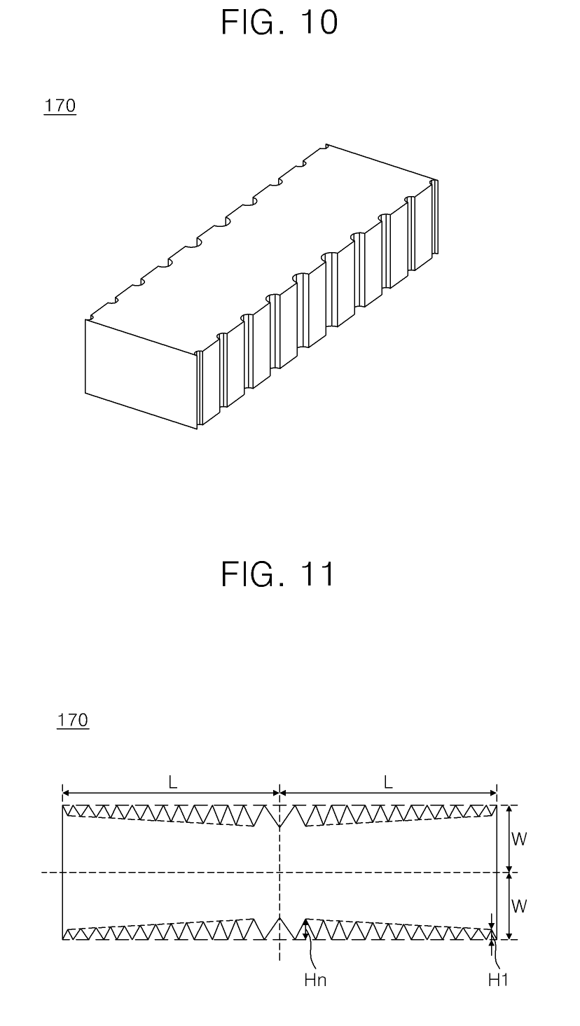

FIG. 9 is a plan view showing a light guide according to another exemplary embodiment of the present invention, and FIG. 10 is a perspective view showing the light guide of FIG. 9. The light guide of FIG. 9 and FIG. 10 has a similar configuration to the light guide of FIG. 3 and FIG. 4 except that the grooves have a semicircular shape.

Referring to FIG. 9 and FIG. 10, the grooves have a semicircular shape and the depth of the semicircular grooves increases approaching the center of the light guide 170 from both ends. Thus, Hn is greater than H1. Alternatively, the semicircular grooves may have the same depth at both ends and at the center of the light guide 170 (i.e. Hn=H1).

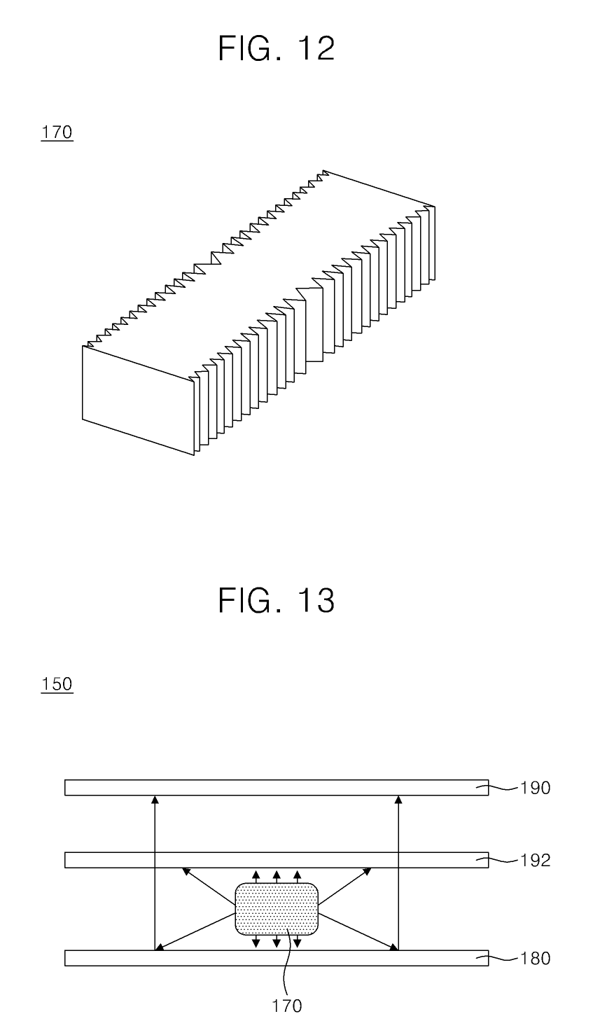

FIG. 11 is a plan view showing a light guide according to another exemplary embodiment of the present invention, and FIG. 12 is a perspective view showing the light guide of FIG. 11. The light guide of FIG. 11 and FIG. 12 has a similar configuration to the light guide of FIG. 3 and FIG. 4 except that the grooves are continuously formed without a gap therebetween.

Referring to FIG. 11 and FIG. 12, the depth of each groove of the light guide 170 increases approaching the center of the light guide 170 from both ends. Alternatively, the grooves of the light guide 170 may have the same depth at both ends and at the center of the light guide 170. In addition, the grooves of the light guide 170 may have the same shape as that of any of FIG. 5, FIG. 6, FIG. 7, FIG. 8, FIG. 9, and FIG. 10 without an interval therebetween.

FIG. 13 is a cross-sectional view showing a backlight assembly according to a first exemplary embodiment of the present invention, taken in a longitudinal direction of the LCD panel.

Referring to FIG. 13, the backlight assembly 150 according to this exemplary embodiment of the present invention includes a light source (not shown), a light guide 170, a reflecting plate 180, a diffusing sheet 192, and a diffusing plate 190, a prism sheet (not shown), and a protector sheet (not shown).

The characteristics and functions of the components of the backlight unit have already been described above and therefore, the detailed descriptions thereof are omitted.

The diffusing sheet 192, which may be further arranged on the light guide 170, reflects light vertically from the light guide 170 and reflecting plate 180 to the LCD panel and diffuses light to have a wide and uniform distribution before being irradiated to the LCD panel. The diffusing sheet 192 may be a transparent resin film, both sides of which may be coated with a predetermined light diffusing member.

This exemplary embodiment may be implemented as a dual-diffusing plate structure by providing another diffusing plate instead of the diffusing sheet 192 on the light guide 170.

Light is supplied from the light source to the light guide 170, which functions to guide light. Light may be efficiently directed upward by the grooves formed on the light guide 170. Light emitted from a top side of the light guide 170 is directed to the diffusing sheet 192 and the diffusing plate 190. Light emitted from a bottom and both sides of the light guide 170 is refracted upward and reflected by the reflecting plate 180.

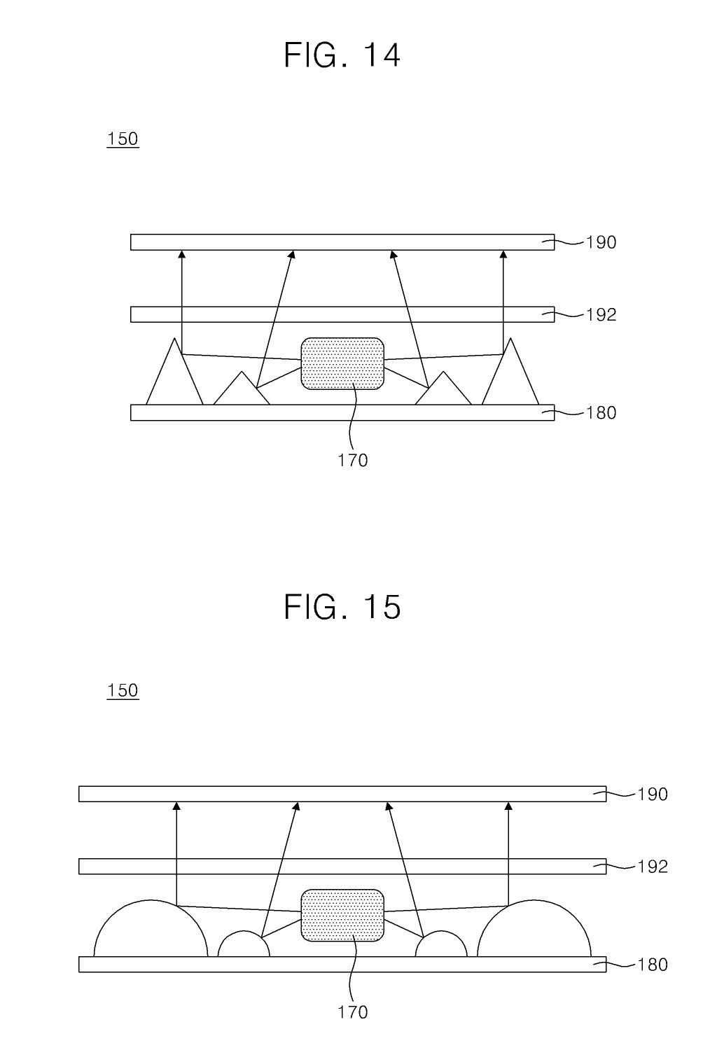

FIG. 14 is a cross-sectional view showing a backlight assembly according to a second exemplary embodiment of the present invention.

Referring to FIG. 14, the backlight assembly 150 according to the second exemplary embodiment of the present invention includes a light source (not shown), a light guide 170, a reflecting plate 180 having a reflecting pattern, a diffusing sheet 192, a diffusing plate 190, a prism sheet (not shown), and a protector sheet (not shown).

The structures and functions of the components of the backlight assembly have already been described above and therefore, the detailed descriptions thereof are omitted. The reflecting plate 180 may have triangle-shaped reflecting patterns, but the shape of the reflecting pattern is not limited to such and may alternatively have a polygonal form.

Like the first exemplary embodiment of the present invention, this exemplary embodiment may be implemented as a dual-diffusing plate structure by providing another diffusing plate instead of the diffusing sheet 192 on the light guide 170.

Light is supplied from the light source through the light guide 170 to the LCD panel, and the reflecting patterns, which are formed in the reflecting plate 180, can efficiently refract and reflect light, which may increase the uniformity of light.

Although the reflecting patterns are formed in a protruded manner in this exemplary embodiment, the reflecting patterns may also be formed in a depressed manner. The reflecting patterns of the reflecting plate 180 serve to refract and reflect light upward from the bottom and both sides of the light guide 170, which may improve the uniformity of light in the LCD panel.

FIG. 15 is a cross-sectional view showing a backlight assembly according to a third exemplary embodiment of the present invention.

Referring to FIG. 15, the backlight assembly 150 according to the third exemplary embodiment of the present invention includes a light source (not shown), a light guide 170, a reflecting plate 180 having a reflecting pattern, a diffusing sheet 192, a diffusing plate 190, a prism sheet (not shown), and a protector sheet (not shown).

Like the first and second exemplary embodiments of the present invention, this exemplary embodiment may be implemented as a dual-diffusing plate structure by providing another diffusing plate instead of the diffusing sheet 192 on the light guide 170.

The structures and functions of the components of the backlight assembly have already been described above and therefore, the detailed descriptions thereof are omitted. The reflecting plate 180 may have semicircle-shaped reflecting patterns. The shape of each reflecting pattern is not limited to such and may have various other forms, such as a curved surface.

Although the reflecting patterns are formed in a protruded manner, the reflecting patterns may also be formed in a depressed manner in this exemplary embodiment. The reflecting patterns of the reflecting plate 180 serve to refract and reflect light upward from the bottom and both sides of the light guide 170.

The reflecting patterns formed in the reflecting plate 180 may improve the uniformity of light without an additional cost or change in design. The reflecting patterns can be formed in various shapes, as discussed above. Rounded reflecting patterns may be especially advantageous in terms of uniformity and thin size and polygonal reflecting patterns may be more advantageous in terms of easiness of fabrication and reliability.

As described above, the backlight assembly according to exemplary embodiments of the present invention may have a plurality of LEDs and a plurality of light guides with grooves, which may prevent a difference in brightness between an area around the light source and other portions of the display.

The light efficiency may be improved by adding the diffusing sheet or employing the two diffusing plates.

Since the reflecting plate has reflecting patterns, the refractive and reflective efficiency of the reflecting plate may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A backlight assembly, comprising:
a light guide having a long stick shape with a rectangular cross-section and including a plurality of emitting patterns in both side of the light guide;
a light source arranged at least one end of the light guide; and
a reflecting plate arranged below the light guide to reflect light emitted from the light guide.

2. The backlight assembly of claim 1, wherein the emitting patterns comprise grooves.

3. The backlight assembly of claim 2, wherein the grooves are spaced apart from each other.

4. The backlight assembly of claim 2, wherein the depth of each groove increases from the at least one end toward a center of the light guide.

5. The backlight assembly of claim 2, wherein the depth of each groove at the both ends is substantially the same with the depth of each groove at the center of the light guide.

6. The backlight assembly of claim 2, wherein each groove has a V-shaped cross section.

7. The backlight assembly of claim 6, wherein each groove has a curved surface.

8. The backlight assembly of claim 2, wherein the grooves are symmetrical with respect to a central axis of the light guide.

9. The backlight assembly of claim 1, wherein the light source comprises at least one light emitting diode (LED).

10. The backlight assembly of claim 1, further comprising a prism sheet arranged above the light guide.

11. The backlight assembly of claim 10, wherein a longitudinal direction of the light guide crosses a longitudinal direction of the prism sheet.

12. The backlight assembly of claim 1, wherein the grooves are continuously formed without a gap therebetween.

13. The backlight assembly of claim 1, wherein the reflecting plate comprises a reflecting pattern to reflect and refract light emitted from the light guide.

14. The backlight assembly of claim 13, wherein the reflecting pattern comprises protrusions or depressions.

15. The backlight assembly of claim 14, wherein the reflecting pattern comprises a curved surface.

16. A backlight assembly, comprising:
a light guide;
a first driving circuit board arranged at least one end of the light guide and comprising a first light source; and
a bottom chassis accommodating the light guide and the first driving circuit board,
wherein the first driving circuit board is arranged on a first side of the bottom chassis.

17. The backlight assembly of claim 16, wherein:
the bottom chassis comprises a bottom surface and the first side, a second side, a third side, and a fourth side extending from the bottom surface;
the first driving circuit board is arranged directly on the first side of the bottom chassis; and
the light guide extends above and across the bottom surface from the first side to the third side, the third side opposing the first side.

18. The backlight assembly of claim 17, further comprising a second driving circuit board arranged directly on the third side of the bottom chassis and comprising a second light source at an end of the light guide.

19. A liquid crystal display apparatus comprising:
a display panel including a first substrate, a second substrate facing the first substrate and a liquid crystal layer between the first substrate and the second substrate; and
a backlight assembly including a light guide and a light source arranged at least one end of the light guide, the light guide having a long stick shape with a rectangular cross-section and having a plurality of emitting patterns in both side of the light guide.

20. The display apparatus of claim 19, wherein the emitting patterns comprise grooves, and
the depth of each groove increases from the at least one end toward a center of the light guide.
